(19) United States
(12) Patent Application Publication
(10) Pub. No.: US 2011/0251765 A1
(43) Pub. Date: Oct. 13, 2011

(54) METHOD FOR THE CONTROL OF A SHIFTING OPERATION OF AN AUTOMATIC TRANSMISSION

(75) Inventors: Martin GENTILE, Ruesselsheim-Koenigstaedten (DE); Thomas ROTH, Freigericht (DE)

(73) Assignee: GM GLOBAL TECHNOLOGY OPERATIONS, INC., Detroit, MI (US)

(21) Appl. No.: 12/954,177

(22) Filed: Nov. 24, 2010

(30) Foreign Application Priority Data
Nov. 26, 2009 (DE) 102009055833.0

(51) Int. Cl. F16H 61/02

(52) U.S. Cl. 701/58

(57) ABSTRACT

A method is provided for the control of a shifting operation of an automatic transmission by means of an electronic transmission control unit. The transmission control unit receives of a maximum engine rotational speed EGSmax from an engine control unit, compares the current engine rotational speed EGScurrent with the maximum engine rotational speed EGSmax, and initiates upshifting if EGScurrent≧EGSmax-x, where x is a calibratable offset.

### CROSS-REFERENCE TO RELATED APPLICATION

This application claims priority to German Patent Application No. 102009055833.0, filed Nov. 26, 2009, which is incorporated herein by reference in its entirety.

### TECHNICAL FIELD

The technical field relates to a method for the control of a shifting operation of an automatic transmission that is initiated by a transmission control unit.

### BACKGROUND

Typically, a transmission control unit establishes shifting points by means of shifting characteristics stored in a data memory dependent on a desired acceleration and/or dependent on a transmission output speed. For various reasons, it may be necessary to correct such shifting points. From DE 10 2007 045 339 A1 it is known for example to carry out an adaptive correction in order to take into account specific shifting characteristics and reaction times during the shifting operation.

At least one object is to provide method with which the shifting operations can be suitably initiated in an automatic transmission, where on the one hand overload and aggravated wear of the engine are prevented; on the other hand a high level of driving comfort is to be ensured.

### SUMMARY

With a method for the control of a shifting operation of an automatic transmission by means of an electronic transmission control unit according to an embodiment, the transmission control unit at least carries out the following steps: it receives a value for a maximum engine rotational speed EGSmax from an engine control unit and compares the current engine rotational speed EGScurrent with the maximum engine rotational speed EGSmax. If the current engine rotational speed is greater than or equal to the maximum engine rotational speed reduced by a calibratable offset x, (i.e., EGScurrent≧EGSmax-x), the transmission control unit initiates upshifting.

The method has a number of advantages. For example, determining the maximum engine rotational speed EGSmax is carried out by the engine control unit. For this reason, only the value EGSmax is sent to the transmission control unit. In this manner, the software used as a base can be established in a modular manner and the interfaces, more preferably between engine and transmission control unit, kept simple and clear. In addition it is possible to correct the maximum permissible engine rotational speed to various even internal engine parameters such as engine friction or output power of the engine actually applied to the crankshaft. By this it is ensured that the maximum load of the engine is optimally matched to the prevailing conditions.

According to an embodiment, the transmission control unit carries out at least the additional step: in the event of a command for shifting down into a lower gear it compares the engine rotational speed EGSlg in the lower gear with the maximum engine rotational speed EGSmax and prevents downshifting if the engine rotational speed EGSlg in the lower gear is greater than or equal to the maximum engine rotational speed reduced by a calibratable offset y (i.e., EGSlg≧EGSmax-y). If the engine rotational speed EGSlg in the lower gear is smaller than the maximum engine rotational speed reduced by the calibratable offset y, downshifting is initiated.

The method has the advantage that at any time the driving comfort that is optimal for the currently permissible load of the engine is guaranteed. The problem of an upshifting operation being possibly omitted with gearshifts according to the prior art since the shifting point is at an engine rotational speed that is higher than the maximum permissible one is solved by taking into account a corrected maximum engine rotational speed in determining the shifting point.

During the correction of the maximum engine rotational speed various external and also internal engine quantities can be taken into account. More preferably, at least one of the quantities ambient temperature, cooling water temperature, temperature of the intake air, ambient pressure, engine friction and output power of the engine applied to the crankshaft can be incorporated in the maximum engine rotational speed EGSmax determined by the engine control unit. Additional correction is possible by means of the quantities x and y. Here, x changes of the engine rotational speed EGScurrent are incorporated in the calibratable offset during the up shift operation and y changes of the engine rotational speed EGScurrent are incorporated in the calibratable offset during the downshift operation. Because of this, lead and reaction times of the transmission and/or of the control are taken into account.

### BRIEF DESCRIPTION OF THE DRAWINGS

The present invention will hereinafter be described in conjunction with the following drawing figures, wherein like numerals denote like elements, and:

FIG. 1 shows a block diagram of an electronic control system with a transmission control; and

FIG. 2 shows the sequence of a method for the control of a shifting operation of an automatic transmission according to an embodiment by means of a flow diagram.

### DETAILED DESCRIPTION

The following detailed description is merely exemplary in nature and is not intended to limit application and uses. Furthermore, there is no intention to be bound by any theory presented in the preceding background or summary or the following detailed description.

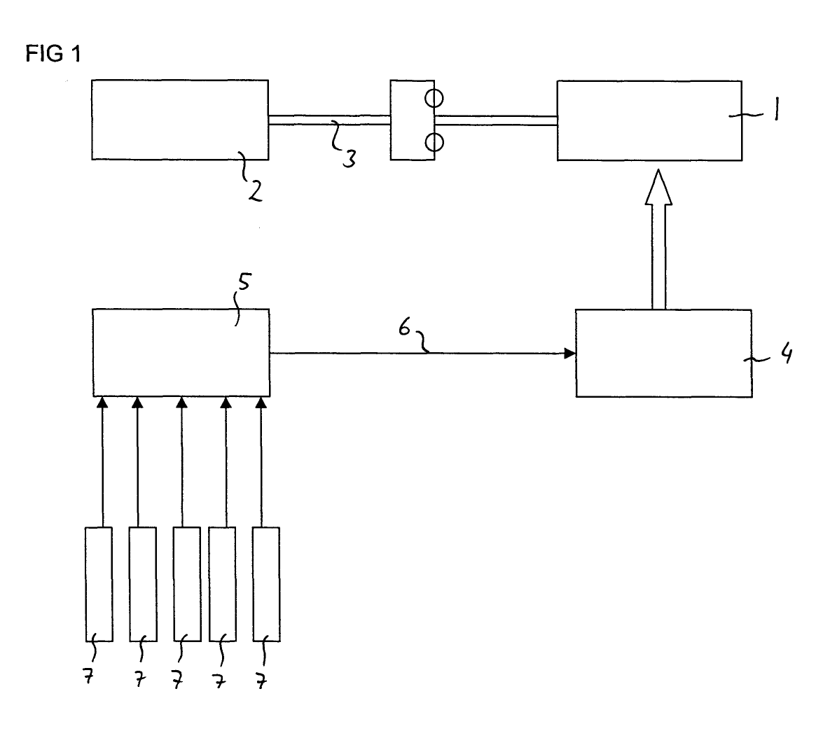

FIG. 1 shows an automatic transmission 1 coupled to an engine 2 via a crankshaft 3. The automatic transmission 1 receives commands for upshifting or downshifting dependent on the current engine rotational speed EGScurrent from a transmission control unit 4. To this end, a set of shifting characteristics of the automatic transmission 1 is stored in a data memory of the transmission control unit 4 which is not shown, wherein each shifting characteristic includes the information for a defined gear change at which speed or rotational speed and which load settings or accelerator pedal position the gear change is to be triggered.

Via a CAN-Bus 6 an engine control unit 5 is connected to the transmission control unit 4. Via this data connection the engine control unit 5 informs the transmission control unit 4 of a corrected value for a maximum engine rotational speed EGSmax which must not be exceeded. To this end, the constructionally related set value EGSmax,0 for the maximum engine rotational speed is corrected with the help of a plurality of parameters taking into account the current situation, more preferably with the help of the ambient temperature, the temperature of the intake air, the ambient pressure, the cooling water pressure, the engine friction and the output power of the engine applied to the crankshaft, which can be reduced for example due to a plurality of electrical consumers. In general, a downward correction of the maximum engine rotational speed takes place so that the corrected value EGSmax is smaller than the constructionally related set value EGSmax for the maximum engine rotational speed.

The parameters for the correction are made available to the engine control unit 5 by a series of sensors 7, for example temperature and pressure sensors. The corrected value EGSmax is calculated by the engine control unit 5 which supplies said value to the transmission control unit 4.

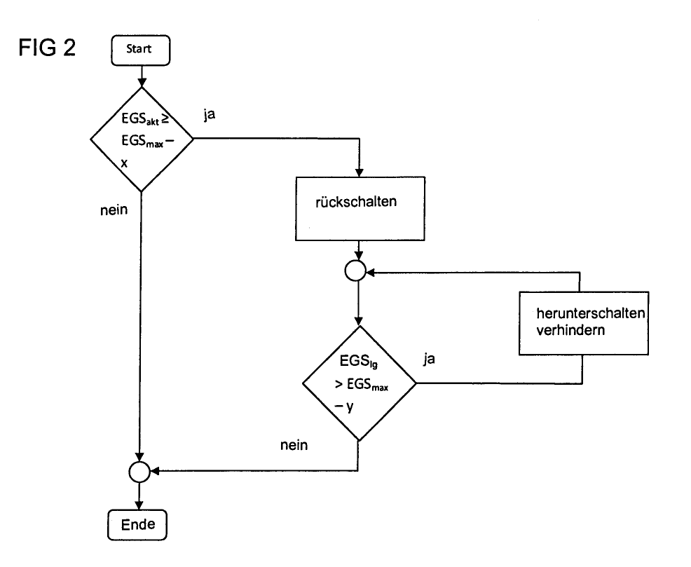

FIG. 2 shows the sequence of the method for the control of the shifting operation of the automatic transmission 1 according to FIG. 1 by means of a flow diagram. The transmission control unit 4 compares the maximum engine rotational speed EGSmax received from the engine control unit 5 with the current engine rotational speed EGScurrent. If the current engine rotational speed EGScurrent is greater than or equal to a maximum engine rotational speed EGSmax reduced by a calibratable offset x, the transmission control unit 4 initiates upshifting of the automatic transmission 1. If the current engine rotational speed EGScurrent is smaller than the maximum engine rotational speed EGSmax reduced by a calibratable offset x, no shifting operation is initiated. If the transmission control unit 4 following upshifting would give a command for downshifting into a lower gear because of the shifting characteristic, it is checked if the engine rotational speed EGSlg in the lower gear would be greater than or equal to the engine rotational speed EGSmax reduced by a calibratable offset y. If this were the case, downshifting is prevented. However, if the engine rotational speed EGSlg in the lower gear were smaller than the maximum engine rotational speed EGSmax reduced by the calibratable offset y, the transmission control unit 4 initiates the shifting operation.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for control of a shifting operation of an automatic transmission, comprising:
receiving, with a transmission control unit, a maximum engine rotational speed (EGSmax) from an engine control unit; and
comparing, with the transmission control unit, a current engine rotational speed (EGScurrent) with the maximum engine rotational speed (EGSmax); and
initiating an upshifting if EGScurrent≧EGSmax-x,
wherein x is a first calibratable offset.

2. The method according to claim 1, the method further comprising:
comparing, with the transmission control unit, a engine rotational speed (EGSlg) in a lower gear with the maximum engine rotational speed (EGSmax) in event of a command for downshifting into the lower gear; and
preventing downshifting if EGSlg≧EGSmax-y,
wherein y is a second calibratable offset.

3. The method according to claim 1, further comprising incorporating changes of the current engine rotational speed (EGScurrent) in the first calibratable offset (x) during the upshifting.

4. The method according to claim 2, further comprising incorporating changes of the current engine rotational speed (EGScurrent) in the second calibratable offset (y) during downshifting.

5. The method according to claim 1, further comprising incorporating a temperature in the maximum engine rotational speed (EGSmax) determined by the engine control unit.

6. The method according to claim 1, further comprising incorporating a pressure in the maximum engine rotational speed (EGSmax) determined by the engine control unit.

7. The method according to claim 1, further comprising incorporating engine friction in the maximum engine rotational speed (EGSmax) determined by the engine control unit.

8. The method according to claim 1, further comprising incorporation output power of an engine applied to a crankshaft in the maximum engine rotational speed (EGSmax) determined by the engine control unit.

9. An apparatus for the controlling a shifting operation of an automatic transmission, comprising:
an engine control unit adapted to provide a maximum engine rotational speed (EGSmax);
a transmission control unit adapted to:
receive the maximum engine rotational speed (EGSmax) from the engine control unit;
compare a current engine rotational speed (EGScurrent) with the maximum engine rotational speed (EGSmax); and
initiating upshifting if EGScurrent≧EGSmax-x,
wherein x is a first calibratable offset.

10. The apparatus according to claim 9, the transmission control unit further adapted to:
compare a engine rotational speed (EGSlg) in a lower gear with the maximum engine rotational speed (EGSmax) in event of a command for downshifting into the lower gear; and
prevent downshifting if EGSlg≧EGSmax-y,
wherein y is a second calibratable offset.

11. The apparatus according to claim 9, the transmission control unit further adapted to incorporate changes of the current engine rotational speed (EGScurrent) in the first calibratable offset (x) during the upshifting.

12. The apparatus according to claim 10, the transmission control unit further adapted to incorporate changes of the current engine rotational speed (EGScurrent) in the second calibratable offset (y) during downshifting.

13. The apparatus according to claim 10, the transmission control unit further adapted to incorporate a temperature in the maximum engine rotational speed (EGSmax) determined by the engine control unit.

14. The apparatus according to claim 9, the transmission control unit further adapted to incorporate a pressure in the maximum engine rotational speed (EGSmax) determined by the engine control unit.

15. The apparatus according to claim 9, the transmission control unit further adapted to incorporate engine friction in the maximum engine rotational speed (EGSmax) determined by the engine control unit.

16. The apparatus according to claim 9, the transmission control unit further adapted to incorporate output power of an engine applied to a crankshaft in the maximum engine rotational speed (EGSmax) determined by the engine control unit.
